(19) United States
(12) Patent Application Publication
(10) Pub. No.: US 2020/0366095 A1
(43) Pub. Date: Nov. 19, 2020

(54) RESILIENT MICROGRID DISTRIBUTION TECHNIQUES

(71) Applicants: Carl J. Moeller, San Antonio, TX (US); Alan McDonnell, Merrimack, NH (US)

(72) Inventors: Carl J. Moeller, San Antonio, TX (US); Alan McDonnell, Merrimack, NH (US)

(21) Appl. No.: 15/930,001

(22) Filed: May 12, 2020

Related U.S. Application Data
(60) Provisional application No. 62/846,962, filed on May 13, 2019.

(51) Int. Cl. H02J 3/32; H02J 3/42; H02J 3/38

(52) U.S. Cl. CPC H02J 3/32; H02J 2203/20; H02J 3/381; H02J 3/42

(57) ABSTRACT

Techniques for providing resilient energy distribution are provided. In an example, a microgrid can include a resilient circuit for supplying user equipment energy during a utility grid disruption and for supplying supplemental energy when the utility grid is not disrupted. The resiliency circuit can allow the microgrid to transition between utility disruption events and non-disruption intervals without disrupting energy to the user equipment.

### CLAIM OF PRORITY

This application claims the benefit of priority to Moeller et al., U.S. Provisional Patent Application Ser. No: 62/846962, titled, RESILIENT MICROGRID DISTRIBUTION TECHNIQUES, filed May 13, 2019 and hereby incorporated by reference herein in its entirety.

### TECHNICAL FIELD OF THE DISCLOSURE

The present disclosure is related to supply techniques for electrical equipment, and more particularly, resilient supply techniques for critical electrical equipment.

### BACKGROUND

With the development of electronics and the easy storage, and exchange of information, many aspects of what people take for granted in their day-to-day activities can rely on the continuous operation of electronic devices that operate to receive, process, store and provide that information. Unreliable energy to run such backbone equipment can cause tangible and intangible harm to the users of the equipment and the institutions that rely on the equipment for providing information services. Such backbone equipment can include, but is not limited to, a data center.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an existing energy distribution architecture for a facility or campus.

FIG. 2 illustrates generally an example energy distribution system according to the present subject matter.

FIG. 3 illustrates generally an example resiliency block.

FIG. 4 illustrates an example method of operating a microgrid with an example resiliency block.

### DETAILED DESCRIPTION

The present inventors have recognized techniques for providing energy to a facility that relies on at least some of the equipment having a source of energy to be “on” all the time. A data center is one type of such a facility. Other types of facilities can include, but are not limited to, hospital campuses, network control centers, research campuses, communication centers, and transportation facilities such as an airport campus. Such facilities can often include a microgrid. A microgrid can be a local energy grid with control capability, which means it can disconnect from the traditional grid and operate autonomously. Microgrids can range in size from a microgrid capable of supplying energy to a single building to a microgrid capable of supplying energy to a neighborhood or an entire city. Examples discussed herein are based on a data center facility, but the scope of the subject matter is not so limited.

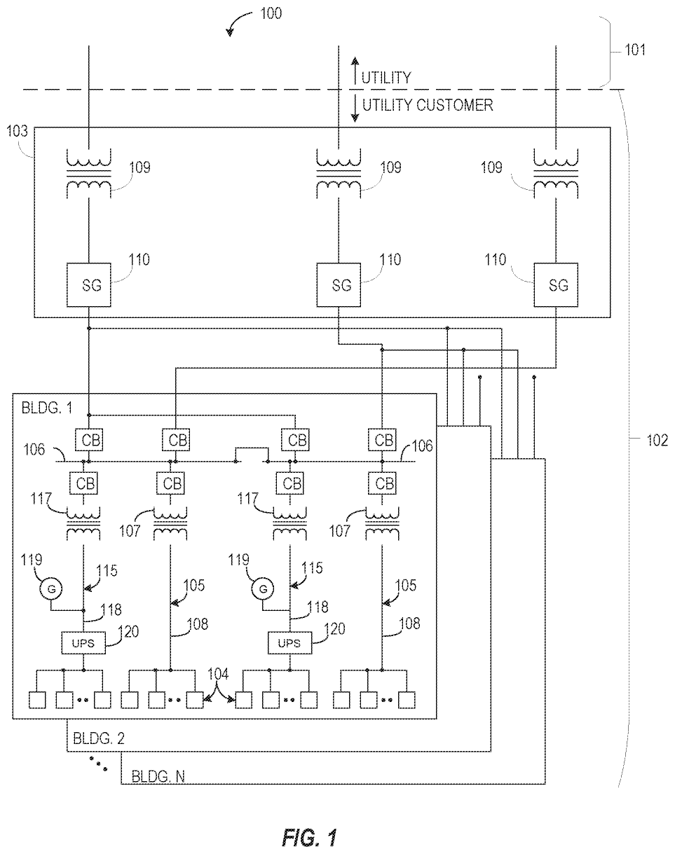

FIG. 1 illustrates generally an existing energy distribution architecture 100 for a facility or campus. The distribution architecture 100 can include a traditional grid system 101 providing one or more connections and a microgrid system 102. The microgrid system 102 can include, a substation 103 and one or more sub-systems, such as buildings (BLDG. 1, BLDG. 2, . . . , BLDG. N), receiving energy from the substation 103. The substation 103 can receive one or more high voltage supply branches from the traditional grid system 101 and can include transformers 109 and switchgears 110 to provide medium voltage feeds for one or more sub-systems. One or more of the buildings can include user equipment 104. The user equipment 104 can be of one or more classes. A first class of user equipment 104 can be user equipment that can shut down or be reset as a result of an energy disturbance or power outage, and a second class of user equipment 104 can be user equipment desired to remain operational even during energy disturbances and power outages. The first class of user equipment 104 can be coupled to a first distribution network 105 including a medium voltage bus 106 received from the substation 103, one or more transformers 107 for providing low voltage AC 108 energy to power the user equipment 104 and associated circuit protection devices such as circuit breakers (CB) or fuses. The second class of user equipment 104 can be coupled to a second distribution network 115 including the medium voltage bus 106, one or more transformers 117 for providing low voltage AC 118 energy to power the user equipment 104, associated circuit protection devices such as circuit breakers (CB) or fuses, and backup power generating equipment such as diesel or gas generators 119 or a plurality of uninterruptable power supplies 120. The illustrated system 100 shows an N+1 form of redundancy for the second class of user equipment 104 such that if part of the system failed with respect to supplying energy, each node of user equipment of the second class has a spare power source including the uninterruptable power supply 120 and a spinning generator 119. Should a sub-system or building lose power, the UPS 120 can supply power to a node of user equipment 104 of the second class while a corresponding generator 119 powers up. Upon power up of the generator 119, the generator 119 can supply energy to the respective node of user equipment 104 of the second class. The illustrated backup architecture 100 operates on a low voltage AC bus (<600 VAC). Due to limitations of UPS systems to quickly supply large amounts of energy, large facilities can have many nodes of user equipment of the second class and, therefore, have many sets of backup systems.

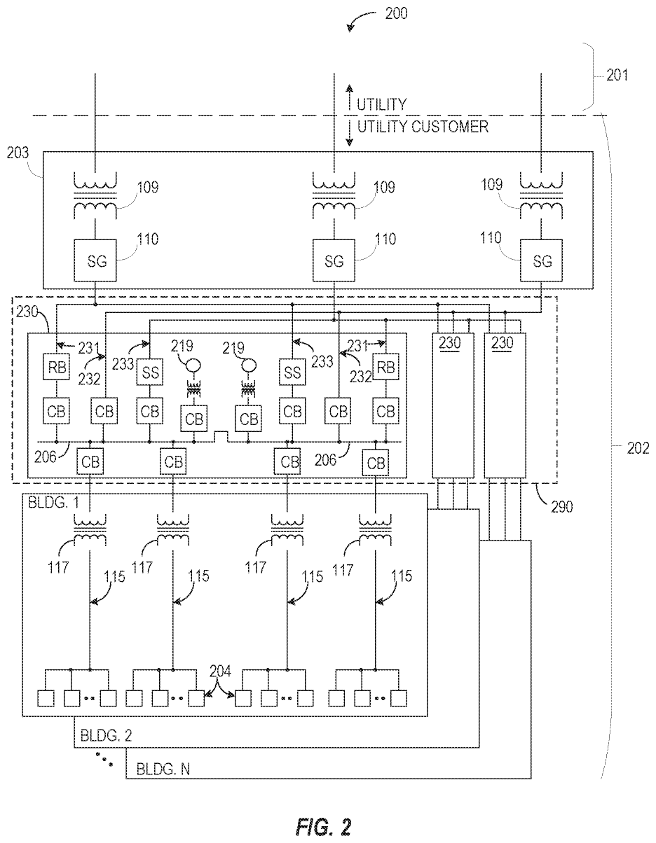

FIG. 2 illustrates generally an example power distribution system 200 according to the present subject matter. The distribution architecture 200 can include a tradition grid system 201 providing one or more connections and a microgrid system 202. The microgrid system 202 can include, a substation 203, a resiliency system 230, and one or more sub-systems, such as buildings (BLDG. 1, BLDG. 2, . . . , BLDG. N), receiving power from the substation 203 or the resiliency system 203. One or more of the buildings can include user equipment 204 of the first class (not shown) or the second class. The resiliency system 230 can provide energy redundancy and resiliency. The illustrated system 200 can provide 2N redundancy. The resiliency system 230 can include one or more sub-networks including a medium voltage bus (>600V and <69 kV) 206. Some definitions narrow medium voltage to >1 kV to <38 kV. In certain examples, each sub-network can include a first supply branch 231 including a resiliency circuit (RB), also referred to as a resiliency block, to provide carry-through energy and full power in case all power is lost for the traditional grid system 201. The first supply branch 231 can provide a range of the overall power to the underlying user equipment 204 when the system is receiving specified power from the traditional grid system 201. In certain examples, the resiliency system 230 can include a second feed branch 232 to directly connect the substation 203 to the medium voltage bus 206. The second feed branch 232 can be utilized while the first branch 231 is offline such as for maintenance but can be used at other times as well. In certain examples, each sub-network can include a third feed branch 233 including an optional static switch (SS) to couple the medium voltage bus 206 with the substation 203. The static switch (SS) can allow for fast transition between isolating the medium voltage bus 206 from the traditional grid 201 and reconnecting the medium voltage bus 206 with the traditional grid 201. The static switch (SS) can react in less than one AC cycle compared to a conventional circuit breaker (GB) that can take 5 or 6 AC cycles. If the resiliency block (RB) can carry through a switching event of a conventional circuit breaker (CB), the static switch (SS) can be optional. In certain examples, the second feed branch 232, if available, is only used when the one of the first or third feed branches 231, 233 is not available, for example, due to maintenance. In such examples, when the traditional grid system 201 is operating nominally, the third feed branch 233 can provide a majority of the power for the sub-system (building) and the first feed branch 231 can provide a minor fraction of the overall power. If an energy perturbation is detected, the static switch (SS) can operate very quickly to isolate the direct connection of the medium voltage bus 206 from the substation 203 and the first feed branch 231 can transition the microgrid to self-generated power. In certain examples, the 2N redundancy can be achieved by tying the medium voltage bus 206 to medium voltage bus 206 of a second sub-network.

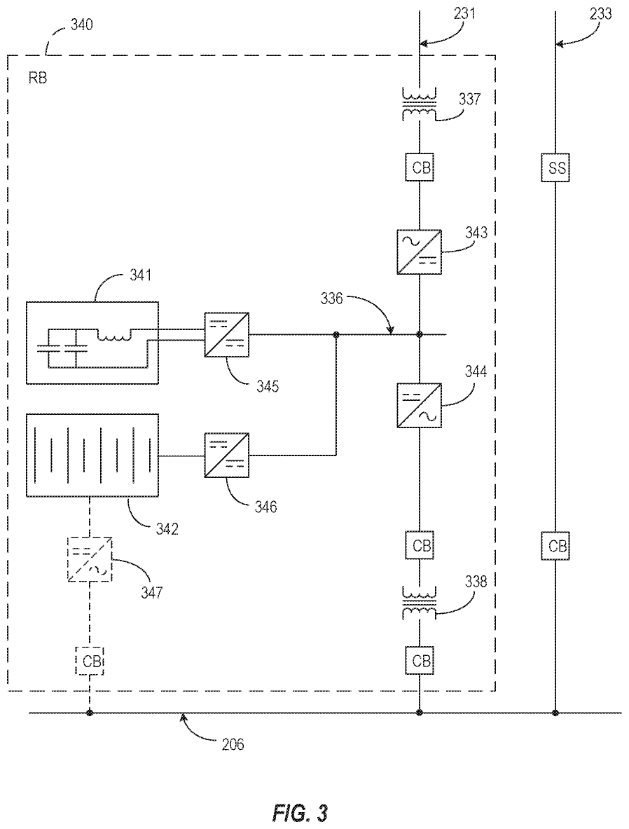

FIG. 3 illustrates generally an example resiliency block 340. The resiliency block 340 can include a DC bus 336 coupled to a medium voltage feed from, for example, a first supply branch 231 of the substation 203 of FIG. 2, to the medium voltage bus 206 of the sub-network, and to one or more power sources, such as a super capacitor assembly 341, a battery assembly 342, an alternative energy generator such a wind generator or solar generator, or combinations thereof. In certain examples, the resiliency block 340 can include one or more transformers 337, 338 to provide a lower medium voltage AC link between to the AC interface of the power converters 343, 344. The resiliency block 340 can include one or more power converters 343, 344, 345, 346 to couple the DC bus 336 to the respective medium voltage nodes and backup or alternative energy sources or power storage devices. For example, a first and second medium voltage power converters/inverters 343, 344 can couple the DC bus 336 with the lower medium voltage link. In certain examples, each of these medium voltage drives 343, 344 can transfer energy between the DC buss 336 and the respective AC link in both directions. A third power converter 345, a DC-DC power converter can exchange energy between the supercapacitor assembly 341 and the DC bus 336. Again, the third power converter 345 can exchange energy in both directions to accommodate providing backup and support power to the microgrid as well as re-charging the capacitors of the super capacitor assembly 341. From a redundancy stand point, the super capacitor assembly 341 can provide full power for a short term (1-20 seconds or more) to allow spinning generators (FIG. 2; 219) or other power sources to ramp up to begin and eventually supply the majority of power to at least the user equipment 204 of the second class. In such a scenario, the spinning generators 219 are typically of a diesel or gasoline fuel type that can ramp up to full power generation in a few seconds. If a battery assembly 342, such as a lithium ion battery assembly is available, the supercapacitor assembly 341 can provide power to allow the battery assembly 342 to ramp up energy output over several AC cycles, and then the battery assembly 342 can provide power for several minutes or hours.

In certain examples, the battery assembly 342 can be coupled to the DC bus via a DC-DC power converter 346. In some examples, as an option, the battery assembly 342 can be coupled to the medium voltage bus 206 via a medium voltage drive 347 instead of being coupled to the DC bus 336. In certain examples, having a battery assembly 342 can further allow for the spinning generation devices 219 to be of a natural gas type generator unit which can take several minutes to power up to full generating capacity. In certain examples, the battery assembly, the alternative energy generator, or a combination thereof, can be coupled to the medium voltage bus 206 via an appropriate power or voltage controller instead of to the DC bus 336. In some examples, the resiliency block 340 may not include a supercapacitor assembly 341. In such examples, the resiliency block can have some form of energy storage such as a battery assembly including, but not limited to, a lead acid battery assembly, a lithium-based battery assembly, or a combination thereof.

In certain examples, the medium voltage drives allow reduction in the complexity of providing redundant power as there are less components to maintain and service compared to the multiple UPS/generator combinations of a conventional system of a similar size. The medium voltage drive can operate much more efficiently than a traditional UPS. For example, a medium voltage drive can operate at more than 97% efficiency over a wide range of loading while a traditional rotary UPS may operate at 94% when loaded above 80% and less efficient if operated below 80%. Medium voltage drives can be easily scaled for applications ranging from 2 MW to 120 MW.

In the illustrated configuration of FIG. 3, in addition to providing back up power, the resiliency block can also support frequency, voltage and power factor. For example, the resiliency block with the super capacitors and medium voltage drives, that are always in some form of energy delivery when enabled, can accept and generate energy on the medium voltage bus very quickly, for example, within less than one AC cycle. Thus, perturbations that affect frequency, voltage, power factor, in rush, or synchronization of the power used by the end user devices, whether the perturbations originate with power coming from the grid or by one or more of the end user devices, can be smoothed by the resiliency block. This is sometimes referred to as a static synchronous compensator (STATCOM). The resiliency function of the resiliency block comes from ability of the power converters to maintain the DC bus at a specified DC voltage either via stored energy or energy received form a feeder branch. When the DC bus is successfully controlled, the energy delivery to the end-user devices is maintained.

An unexpected synergy of the illustrated architecture (e.g., FIG. 2; 290) is that the resiliency system(s) 230 can be easily segmented physically from the traditional grid system 201 and from the systems of the end user equipment 204. Such segmentation can allow for a separate business entity to own or operate the resiliency system(s) 290. Such business segmentation can allow for each entity to develop and improve on the specialized skills needed for their respective core businesses. Other advantages can be attained using an architecture according to the present subject matter. For example, the interconnection process of the microgrid need only occur once over the life of the microgrid. Therefore, if additional alternative energy generating devices are desired to be added to the microgrid and supply the medium voltage bus or a low voltage bus, no additional interconnection agreement or process with the traditional grid operator is generally needed.

If spinning generators are used as a redundant backup system, such generators periodically for maintenance purposes. For conventional system, energy from the maintenance runs of the spinning generators is typically wasted in a load bank. With the medium voltage drives of the example techniques, the energy of the maintenance runs can be used to provide energy to end user devices. In fact, the controllability of the medium voltage drives can facilitate utilization of the diesel generators for peak shaving as allowed by environmental regulation run times.

The controllability of the medium voltage drives can also make the interconnection variable with the traditional grid controllable. Often connecting large generators, solar generation, and storage elements introduces variables such as fault current contribution or significant capacitance that is an issue for the distribution grid interconnection. By having the medium voltage drive as the intermediary, the example techniques can allow control of the amount of fault current provided as well as provide voltage and voltage-ampere-reactive (VAR) control for the utility as a service or necessity for interconnection. The DC coupled microgrid architecture lends itself to variable-universe frequency control (VUFC) that can be used in microgrid island mode to regulate solar and storage elements in a fast control loop instead of using a significant amount of communication controls that are needed in AC connected microgrids. In certain examples, a permanently islanded nature of an MV Drive microgrid allows for easier load flow and frequency control implementations across large assets (5+ MW) that are significantly more difficult in an AC connected microgrid. The large drive acts as a frequency controlling element that is like a ‘sledge hammer’ compared to paralleled tiny inverters on storage or solar or even diesel generators. In certain examples, by having the ability to have a ‘controllable UPS’ architecture, along with the ability to separate the other generation, storage, and reliability assets from the load, a true ‘resiliency as a service’ could be offered by a 3rd party for large reliability customers that could also participate in the independent system operator (ISO) markets. This would be of particular interest in the data center markets where even utilities may want to own the assets to both entice a data center load to come to their territory while also using them as a grid asset. In some examples, diesel generator(s) be replaced with large, natural gas engine generators to provide spinning reserve, frequency regulation, voltage and VAR regulation, and peaking generation.

Furthermore, in some examples, a resiliency energy or power distribution system according to the present subject matter can assist a traditional grid operator with black start processes. A black start is the process of restoring an electric power station or a part of an electric grid to operation without relying on the external electric power transmission network to recover from a total or partial shutdown. During such processes, energy from the resiliency system and the corresponding generators or power storage devices can provide the initial energy to re-establish the traditional grid power generation equipment.

Compared to conventional systems such as the system shown in FIG. 1, the present techniques can reduce switching losses because under normal non-blackout conditions, only a fraction of the energy delivered to the end-user equipment is provided by the resiliency block. Conventional system typically can have the UPS passing all the energy for the user equipment even during non-blackout conditions. In addition, because the resiliency block can quickly change energy delivery, the resiliency block can change between low energy delivery and high-energy delivery (a black out condition with supplemental power generation (spinning generators)) and then back to low energy delivery (non-blackout condition) without the end-user equipment experiencing significant energy disturbances. Conventional system can switch to blackout condition energy supply but typically need to experience a blackout to reconnect the system to the traditional grid.

It is understood that the example of FIG. 2 illustrates only energy distribution for user-equipment of the second class, it is understood that other energy distribution branches not shown can bypass the resiliency system to provide energy to user-equipment of the first class without departing for the scope of the present subject matter. It is also understood that the arrangement of the substation can vary without departing from the scope of the present subject matter. It is also understood that the architecture and techniques can include a controller (not shown) to sequence the solid-state switch and the example resiliency system to optimize energy flow to the user equipment of the second class as discussed herein.

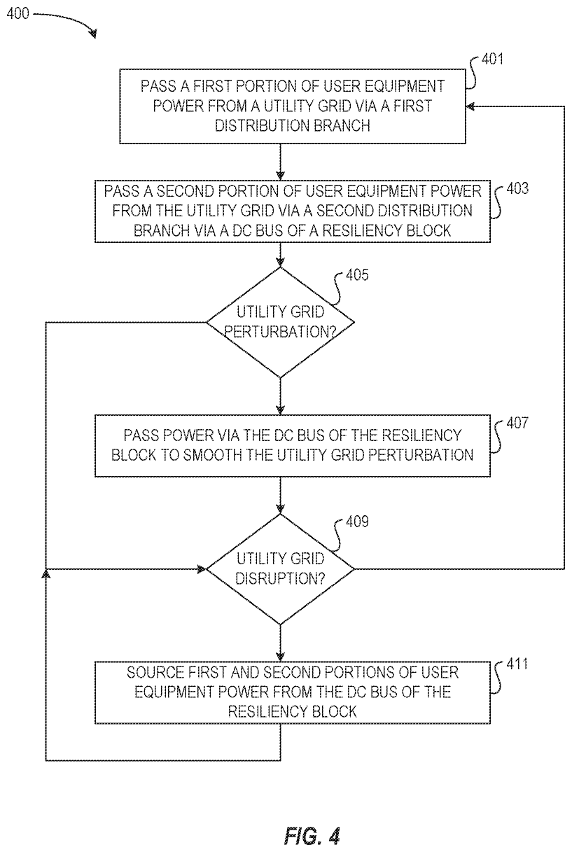

FIG. 4 illustrates an example method 400 of operating a microgrid with an example resiliency block. At 401, a first portion of energy can be supplied from a utility grid via a first distribution branch of a microgrid system to power user equipment. At 403, a second portion of energy can be supplied from the utility grid via a second distribution branch of the microgrid system to power the user equipment. The second distribution branch can include a resiliency block. A DC bus of the resiliency block can provide a path for the second portion of energy. At 405, the utility grid can incur a perturbation such as a voltage deviation, phase drop, etc. At 407, in response to the utility grid perturbation, the resiliency block can quickly source or sink energy to smooth the perturbation. In certain examples, perturbations sourced at the user equipment can be smoothed by the resiliency block to block the perturbation from influencing the utility grid. At 409, the utility grid can incur a sustained disruption such as a brown out or complete power delivery failure. At 411, in response to the grid disruption, the resiliency block can supply the combined portions of the user equipment energy. In some examples, such as for a resiliency block including a super capacitor, the resiliency block can supply the combined energy for a period of time to allow other energy sources, such as spinning generators to come on-line. In some examples, such as for resiliency blocks that include a battery, the resiliency block can supply the combined energy for an extended period of time such as for several minutes or several hours. Upon correction of the utility grid disruption, the energy distribution of the first portion of energy from the utility grid to the user equipment can be re-established without isolating the resiliency block from the microgrid or requiring a blackout of the user equipment.

### VARIOUS NOTES & EXAMPLES

In a first example, Example 1, a resiliency energy distribution system can include a DC bus, a medium voltage bus configured to supply energy to end-user equipment, a supercapacitor assembly coupled to the DC bus, a first medium voltage converter configured to couple a medium voltage supply branch with the DC bus, and a second medium voltage converter configured to couple the medium voltage bus with the DC bus.

In Example 2, the medium voltage bus of Example 1 optionally operates at between 12 kilovolts (kVAC) and 69 kVAC.

In Example 3, the DC bus of any one or more of Examples 1-2 optionally operates at between 1 kVDC and 7.5 kVDC.

In Example 4, the DC bus of any one or more of Examples 1-3 optionally is configured to supply a range of energy to the end-user equipment.

In Example 5, the DC bus of any one or more of Examples 1-4 optionally is configured to supply 10% or less of the energy to the end-user equipment when the medium voltage supply branch is energized.

In Example 6, the DC bus of any one or more of Examples 1-5 optionally is configured to supply 100% of the energy to the end-user equipment when the medium voltage supply branch is not energized.

In Example 7, the DC bus of any one or more of Examples 1-6 optionally is configured to deliver 60 MVA.

In Example 8, a method of operating a resiliency energy distribution system can include passing a first portion of energy for user equipment of a microgrid system from a utility grid via a first switchgear of the microgrid and a static switch of the microgrid, passing a second portion of the energy for the user equipment from the utility grid via a second switch gear of the microgrid and a resiliency circuit of the microgrid, and wherein the resiliency circuit is configured to pass the second portion of the energy at a medium voltage via a DC bus of the resiliency circuit.

In Example 9, the method of any one or more of Examples 1-2 optionally includes supplementing the first portion of the energy via the DC bus of the resiliency circuit in response to a partial disruption of electrical characteristics of the utility grid.

In Example 10, the method of any one or more of Examples 1-9 optionally includes isolating the microgrid at the static switch in response to an energy failure of the utility grid, and providing the first portion of energy and the second portion of the energy via the DC bus of the resiliency circuit in response to isolation of the microgrid from the utility grid at the static switch.

In Example 11, the providing the first portion and the second portion of energy of any one or more of Examples 1-10 optionally includes coupling energy of an energy storage device with the DC bus using a medium voltage DC-DC converter of the resiliency circuit.

In Example 12, the energy storage device of any one or more of Examples 1-11 optionally includes a super capacitor.

In Example 13, the energy storage device of any one or more of Examples 1-12 optionally includes a battery.

In Example 14, the energy storage device of any one or more of Examples 1-13 optionally includes a supercapacitor and a battery.

In Example 15, the method of any one or more of Examples 1-14 optionally includes initiating start-up of a spinning generator in response to isolation of the microgrid from the utility grid at the static switch.

In Example 16, the method of any one or more of Examples 1-2 optionally includes providing the first portion of energy and the second portion of energy using both the resiliency circuit and the spinning generator at a conclusion of the start-up.

In Example 17, in response to correction of the energy failure, the method of any one or more of Examples 1-2 optionally includes connecting the microgrid with the utility grid at the static switch without decoupling the resiliency circuit from the utility grid.

In Example 18, a microgrid system can include a first distribution branch, and a second distribution branch configured to distribute second energy to the user equipment at the same time as the first distribution branch. The second distribution branch can include means for providing resilient energy to the user equipment in response to a disruption of grid energy supplied by the utility grid to the microgrid system.

In Example 19, the means for providing resilient energy of any one or more of Examples 1-18 optionally includes a DC bus configured to distribute the second energy and the resilient energy to the user equipment.

In Example 20, the means for providing resilient energy of any one or more of Examples 1-19 optionally includes a supercapacitor to distribute the second energy and the resilient energy to the user equipment.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, the terms “including” and “comprising” are open-ended, that is, a system, device, article, composition, formulation, or process that includes elements in addition to those listed after such a term are still deemed to fall within the scope of subject matter discussed. Moreover, such as may appear in a claim, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of a claim. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. The following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A resiliency energy distribution system comprising:
a DC bus;
a medium voltage bus configured to supply energy to end-user equipment;
a supercapacitor assembly coupled to the DC bus;
a first medium voltage converter configured to couple a medium voltage supply branch with the DC bus; and
a second medium voltage converter configured to couple the medium voltage bus with the DC bus.

2. The resiliency energy distribution system of claim 1, wherein the medium voltage bus is configured to operate between 12 kilovolts (k VAC) and 69 k VAC.

3. The resiliency energy distribution system of claim 1, wherein the DC bus is configured to operate between 1 k VDC and 7.5 k VDC.

4. The resiliency energy distribution system of claim 1, wherein the DC bus is configured to supply a range of energy to the end-user equipment.

5. The resiliency energy distribution system of claim 1, wherein the DC bus is configured to supply 10% or less of the energy to the end-user equipment when the medium voltage supply branch is energized.

6. The resiliency energy distribution system of claim 5, wherein the DC bus is configured to supply 100% of the energy to the end-user equipment when the medium voltage supply branch is not energized.

7. The resiliency energy distribution system of claim 1, wherein the DC bus is configured to deliver 60 MVA.

8. A method of operating a resiliency energy distribution system, the method comprising:
passing a first portion of energy for user equipment of a microgrid system from a utility grid via a first switchgear of the microgrid and a static switch of the microgrid;
passing a second portion of the energy for the user equipment from the utility grid via a second switch gear of the microgrid and a resiliency circuit of the microgrid; and
wherein the resiliency circuit is configured to pass the second portion of the energy at a medium voltage via a DC bus of the resiliency circuit.

9. The method of claim 8, supplementing the first portion of the energy via the DC bus of the resiliency circuit in response to a partial disruption of electrical characteristics of the utility grid.

10. The method of claim 8, isolating the microgrid at the static switch in response to a energy failure of the utility grid; and
providing the first portion of energy and the second portion of the energy via the DC bus of the resiliency circuit in response to isolation of the microgrid from the utility grid at the static switch.

11. The method of claim 10, wherein the providing the first portion and the second portion of energy includes coupling energy of an energy storage device with the DC bus using a medium voltage DC-DC converter of the resiliency circuit.

12. The method of claim 11, wherein the energy storage device includes a super capacitor.

13. The method of claim 11, wherein the energy storage device includes a battery.

14. The method of claim 11, wherein the energy storage device includes a super capacitor and a battery.

15. The method of claim 11, including initiating start-up of a spinning generator in response to isolation of the microgrid from the utility grid at the static switch.

16. The method of claim 15, including providing the first portion of energy and the second portion of energy using both the resiliency circuit and the spinning generator at a conclusion of the start-up.

17. The method of claim 10, in response to correction of the energy failure, connecting the microgrid with the utility grid at the static switch without decoupling the resiliency circuit from the utility grid.

18. A microgrid system including:
a first distribution branch configured to selectively coupled to a utility grid, and to distribute first energy to user equipment; and
a second distribution branch configured to distribute second energy to the user equipment at the same time as the first distribution branch; and
wherein the second distribution branch includes means for providing resilient energy to the user equipment in response to a disruption of grid energy supplied by the utility grid to the microgrid system.

19. The microgrid system of claim 18, wherein the means for providing resilient energy includes a DC bus configured to distribute the second energy and the resilient energy to the user equipment.

20. The microgrid system of claim 18, wherein the means for providing resilient energy includes a supercapacitor to distribute the second energy and the resilient energy to the user equipment.
